(19) United States
(12) Patent Application Publication
(10) Pub. No.: US 2008/0236403 A1
(43) Pub. Date: Oct. 2, 2008

(54) Percolator For Producing A Beverage From Powdered Material In A Container

(76) Inventor: Virginio Cortese, Torino (IT)

Correspondence Address: LADAS & PARRY LLP, 26 WEST 61ST STREET, NEW YORK, NY, 10023, US

(21) Appl. No.: 11/631,914

(22) PCT Filed: Jul. 12, 2005
(86) PCT No.: PCT/EP05/53335

§ 371 Date: Nov. 26, 2007

(30) Foreign Application Priority Data
Jul. 13, 2004 (IT) TO2004A000480

(51) Int. Cl. A47J 31/00; A47J 31/44

(52) U.S. Cl. 99/323; 99/302 R

(57) ABSTRACT

A percolator, wherein a container, containing a measure of ground coffee, is inserted inside a fixed cup, which has a vertical first axis, is positioned with its concavity facing upwards, and has a lid which rotates, about a second axis crosswise to the first axis, to and from a closed position closing the cup; the lid having a pressurized-hot-water sprinkler which, when the lid is in the closed position, is moved, by a piston carried by the lid, onto the cup to define, with the cup, a percolating chamber for housing the wafer and a bolt device to lock the lid in the closed position.

### TECHNICAL FIELD

The present invention relates to a percolator for producing a beverage from powdered material in a container.

Though the percolator according to the present invention is suitable for producing any beverage by feeding pressurized hot water through powdered material in a container, reference is made in the following description, purely by way of example, to a percolator for producing a coffee beverage from a container containing a measure of ground coffee.

### BACKGROUND ART

In beverage percolation, a coffee percolator is known, for example from U.S. Pat. No. 5,794,519, of the type comprising a cup-shaped support for the coffee container, the cup-shaped support having a first axis and a discharge conduit; a lid hinged to the cup-shaped support to rotate, with respect to the cup-shaped support and about a second axis crosswise to the first axis, to and from a closed position closing the cup-shaped support; pressurized-hot-water supply means carried by the lid and comprising a sprinkler facing the cup-shaped support; and locking means to lock in a fluid tight manner the lid in the closed position to the cup-shaped support; the locking means comprising a coupling device in turn comprising hook means fitted movably to the lid, and hook receiving means carried by the cup-shaped support and engaged by the hook means when the lid is in the closed position.

In known percolators of the type disclosed above, fluid tight connection of the lid in its closed position to the cup-shaped support is assured only by the aforementioned hook means force-engaging the hook receiving means. Since the percolation water is generally supplied to the percolator at a pressure of 9-10 bars, the force to be applied to the hook means to lock in a fluid tight manner the lid to the cup-shaped support is relatively high and normally implies the use of relatively complicated and expensive mechanical or hydraulic force amplifiers.

### DISCLOSURE OF INVENTION

It is an object of the present invention to provide a percolator of the type described above, which is of extremely straightforward, strong design, is relatively cheap to produce and use, and is therefore particularly suitable for household and everyday use.

According to the present invention, there is provided a percolator for producing a beverage from powdered material in a container, as claimed in claim 1 and, preferably, in any one of the following claims depending directly or indirectly on claim 1.

### BRIEF DESCRIPTION OF THE DRAWINGS

The invention will now be described by way of example with reference to the accompanying drawings, in which:

FIGS. 1 and 2 show schematic views in perspective of a preferred embodiment of the percolator according to the present invention in respective different operating configurations;

FIG. 3 shows an axial section of the percolator in the FIG. 2 configuration.

### BEST MODE FOR CARRYING OUT THE INVENTION

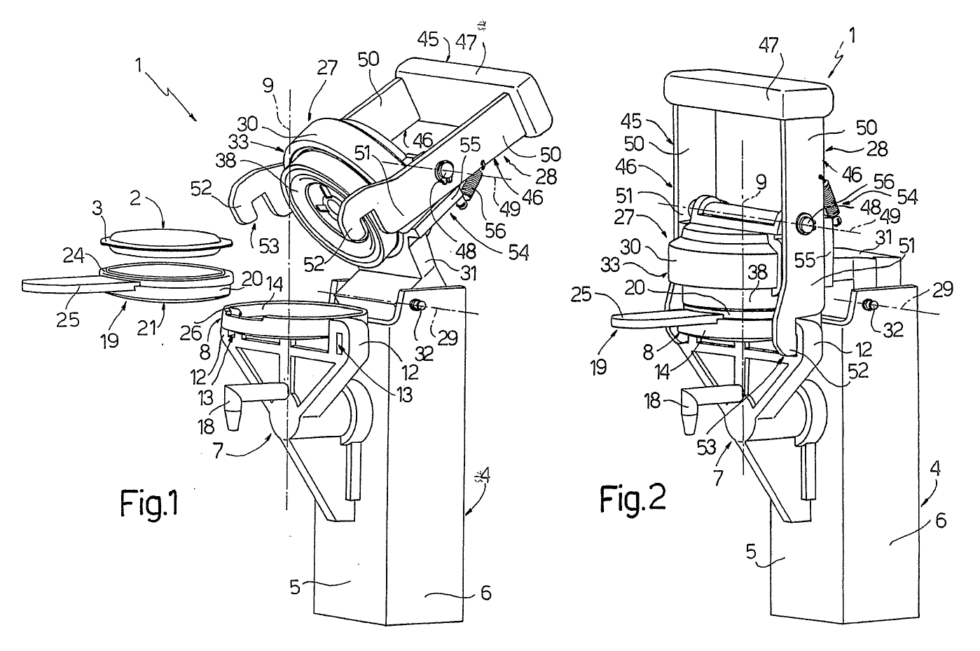

Number 1 in FIG. 1 indicates as a whole a percolator for producing a coffee beverage from a measure of ground coffee contained inside a wafer 2 (of standard type), which is defined by a closed shell made of permeable material and having an outer annular peripheral flange 3.

Percolator 1 comprises a frame 4 comprising a parallelepiped-shaped box body defined by a substantially vertical front wall 5, and by two parallel, substantially vertical lateral walls 6 perpendicular to front wall 5.

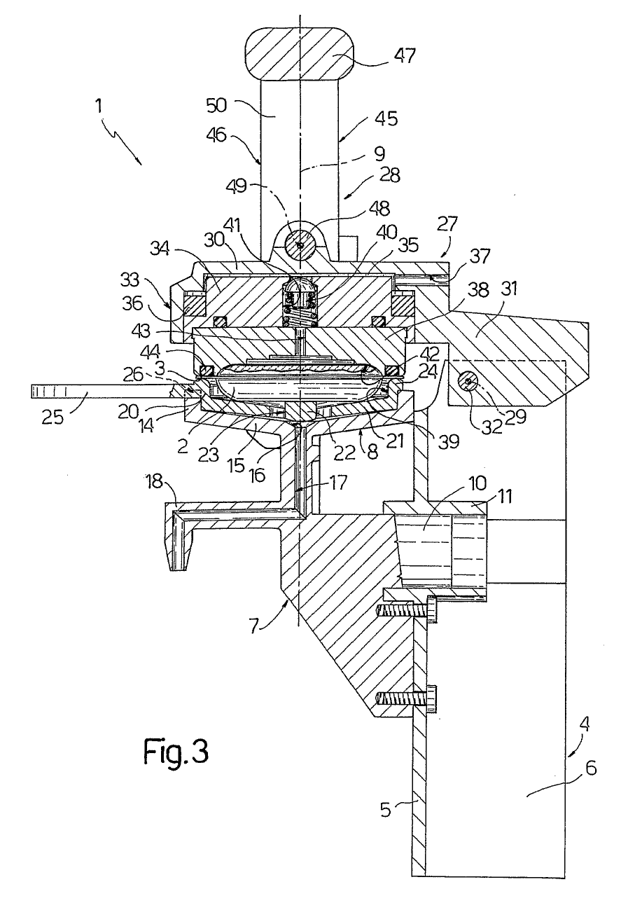

As shown in FIG. 3, front wall 5 is fitted with a projecting supporting body 7 for a fixed cup 8, which has a substantially vertical axis 9 and is positioned with its concavity facing upwards.

Supporting body 7 is fixed rigidly by screws to front wall 5, and has a cylindrical appendix 10 inserted inside a tubular insert 11, which extends through a through hole in front wall 5 and is connected integrally to front wall 5.

Supporting body 7 also has two diametrically opposite appendixes 12 tangent to cup 8, and each of which has a through slot 13 formed crosswise to axis 9 through respective appendix 12. Slots 13 have respective elongated rectangular cross sections, the respective major axes of which are parallel to each other and to axis 9.

Cup 8 is defined by a substantially cylindrical lateral wall 14, and by a downward-tapering conical bottom wall 15 having a central hole 16, which defines the inlet of a discharge channel 17 formed partly inside supporting body 7 and partly inside an L-shaped spout 18 carried by supporting body 7.

Cup 8 houses a removable percolating cup 19 for partly housing a wafer 2, and which comprises a cup-shaped body defined by a cylindrical lateral wall 20, and by a conical bottom wall 21 tapering outwards of cup 19 with a slightly smaller taper than bottom wall 15 of cup 8. As shown in FIG. 3, when cup 19 is housed inside cup 8, the difference in taper between bottom wall 15 and bottom wall 21 forms a gap between bottom walls 15 and 21 to allow the percolated coffee issuing from cup 19 to flow into discharge channel 17.

A central portion 22 of bottom wall 21 is thicker than the rest of bottom wall 21, projects inwards of cup 19, and is bounded on the inside of cup 19 by a flat surface which, in use, defines a supporting surface for a wafer 2 housed inside cup 19, and, during percolation, prevents wafer 2—as it is impregnated with hot water and pressed against bottom wall 21 by the pressure of the water—from clogging a number of coffee outlet holes 23 formed through bottom wall 21, about the whole of central portion 22, and communicating with discharge channel 17 via said gap between bottom wall 21 of cup 19 and bottom wall 15 of cup 8.

The top free edge of lateral wall 20 has an outer annular flange 24 which, when cup 19 is inserted inside cup 8, rests on the free edge of cup 8, and in turn defines a supporting surface for flange 3 of a wafer 2 housed, in use, inside cup 19.

Lateral wall 20 is fitted with a hand-operated external handle 25 which, when cup 19 is inserted inside cup 8, engages a cavity 26 formed on the free edge of cup 8 (FIGS. 2 and 3), on the opposite side to frame 4, to lock cup 19, in use, in a given angular position with respect to cup 8.

As shown in FIGS. 1 and 2, percolator 1 comprises a lid 27 for closing cup 8, and which is hinged to frame 4 to oscillate, under the control of a hand-operated device 28 and about an axis 29 crosswise to axis 9, between a raised open position opening cup 8 (FIG. 1), and a lowered closed position closing cup 8 and locking cup 19 inside cup 8 (FIG. 2).

With reference to FIG. 3, lid 27 comprises a cup-shaped body 30 positioned with its concavity facing cup 8, and fitted to frame 4 by a substantially radial arm 31 hinged at its free end to lateral walls 6 of frame 4 by a pin 32 coaxial with axis 29.

Cup-shaped body 30 defines the outer sleeve of a. hydraulic cylinder 33, which, in addition to cup-shaped body 30, also comprises a piston 34 mounted to slide along cup-shaped body 30 and defining, with cup-shaped body 30, a variable-volume chamber 35 sealed fluidtight by an annular seal 36 interposed between a lateral wall of cup-shaped body 30 and a lateral wall of piston 34. From a known boiler (not shown) fixed to frame 4, chamber 35 is supplied with pressurized hot water, along a feed conduit 37 formed through cup-shaped body 30, to move piston 34 along cup-shaped body 30.

On the end facing cup 8, piston 34 is fitted rigidly with a concave sprinkler 38, which receives pressurized hot water from chamber 35 through piston 34, and is moved, by piston 34 and when lid 27 is in the closed position, to and from a connected position connected in fluidtight manner to cup 19 housed inside cup 8 (FIG. 3), so as to define, with cup 19, a percolating chamber 39.

Pressurized-hot-water flow from chamber 35 to sprinkler 38 is regulated by a known one-way valve 40 housed inside a central hole 41 through piston 34, and calibrated to open when the pressure in chamber 35 and in feed conduit 37 reaches a given value.

Sprinkler 38 is defined by a cylindrical body of substantially the same diameter as cup 19, and having, on a bottom surface facing cup 8, a cavity 42 which defines a top half-chamber of percolating chamber 39 and is equal in depth to roughly half the thickness of a wafer 2. Cavity 42 communicates with chamber 35 via hole 41 and via a hole 43 formed through sprinkler 38 and coaxial with hole 41. An annular, downward-open groove is formed along the periphery of cavity 42 and houses a seal 44.

As shown in FIGS. 1 and 2, device 28 for hand-operating lid 27 comprises a handgrip 45 in turn comprising two rocker arms 46, which are located on opposite sides of hydraulic cylinder 33, are connected to each other at respective ends by a cross member 47, and are hinged, about a pin 48 integral with cup-shaped body 30, to oscillate about an axis 49 parallel to axis 29 and crosswise to axis 9. More specifically, each rocker arm 46 comprises a first arm 50 interposed between cross member 47 and pin 48; and a second arm 51 extending from pin 48 towards cup 8, aligned with respective arm 50, and having a U-shaped end hook 52, which is positioned with its concavity facing frame 4, and, in use, engages a respective slot 13.

As shown in FIG. 1, when lid 27 is in the open position, handgrip 45 is held in position—with cross member 47 upwards and with rocker arms 46 substantially parallel to a longitudinal axis of hydraulic cylinder 33—by a stop device 54 comprising a rib 55, which is carried by lid 27, projects radially from cup-shaped body 30, is interposed between one of rocker arms 46 and arm 31, and prevents handgrip 45 from dropping backwards when lid 27 is moved into the open position. Stop device 54 also comprises a spring 56, which extends between rib 55 and arm 50 of the rocker arm 46 on the same side as rib 55, and, when lid 27 is moved into the open position, holds rocker arm 46 on rib 55 to prevent hooks 52 from banging against the top of relative appendixes 12 when lid 27 is moved into the closed position.

In actual use, after loading a wafer 2 inside cup 19 and inserting cup 19 inside cup 8, the user, positioned facing front wall 5, draws handgrip 4, back to rotate lid 27 about axis 29 and down onto cup 8. When lid 27 is in the closed position (FIGS. 2 and 3), in which sprinkler 38 is coaxial with axis 9, the user continues drawing back cross member 47 to rotate handgrip 45 about axis 49 and engage hooks 52 inside respective slots 13 to fix lid 27 in the closed position.

In this connection it is worth pointing out that, during insertion of hooks 52 inside slots 13, no real pressure is applied since hooks 52, when coupling lid 27 to cup 8, do not generate any axial pressure between lid 27 and cup 8, but only fix lid 27 in the lowered closed position.

When the user turns on machine 1 by means of an external control (not shown), pressurized hot water is pumped along feed conduit 37 into chamber 35, which, on expanding, moves piston 34 down and so moves sprinkler 38 into the engaged position mentioned above, in which sprinkler 38 presses flange 3 of wafer 2 in fluidtight manner against flange 24 of cup 19 (FIGS. 2, 4, 6) and locks lid 27 in the lowered closed position to cup 8. In other words, the axial locking pressure to lock lid 27 to cup 8 is not imparted by hooks 52 force-engaging slots 13, but by hooks 52 resisting, inside slots 13, to the axial pressure applied by piston 34, which defines, together with hooks 52 and slots 13, a bolt-type locking device 53 for locking lid 27 in the closed position.

When percolating chamber 39 is closed, the pressure inside chamber 35 rises rapidly, so that valve 40 opens and pressurized hot water flows through holes 41 and 43 into percolating chamber 39 to produce the coffee, which then flows out through holes 23 in cup 19 and along discharge channel 17.

User operation of a stop button (not shown) cuts off pressurized-hot-water supply and closes valve 40 thus reducing the axial contact pressure between hooks 52 and slots 13 substantially to zero. The user then pushes back, without any real effort, cross member 47 to release hooks 52 from respective slots 13 and move lid 27 back into the open position, in which cup 19 can be removed from cup 8 to unload the used wafer 2 from cup 19.

1. A percolator for producing a beverage from powdered material in a container (2), the percolator (1) comprising a cup-shaped support (8) for said container (2), the cup-shaped support (8) having a first axis (9) and a discharge conduit (17); a lid (27) hinged to the cup-shaped support (8) to rotate, with respect to the cup-shaped support (8) and about a second axis (29) crosswise to the first axis (9), to and from a closed position closing the cup-shaped support (8); pressurized-hot-water supply means (38) carried by the lid (27) and comprising a sprinkler (38) facing the cup-shaped support (8); and bolt means (53) to lock in a fluid tight manner the lid (27) in the closed position to the cup-shaped support (8); the bolt means (53) comprising hook means (52) fitted movably to the lid (27), and hook receiving means (13) carried by the cup-shaped support (8) and slidably engaged by the hook means (52) when the lid (23) is in the closed position; and the percolator being characterized in that the bolt means (53) further comprise a hydraulic cylinder (33) in turn comprising a piston (34) for moving the sprinkler (38), when the lid (27) is in said closed position, along the lid (23) and the first axis (9) to an engaged position where on the one side the sprinkler (38) is coupled to the cup-shaped support (8) in a watertight manner to define, with the cup-shaped support (8), a percolating chamber (39), and, on the other side, the hook means (52) are in a force-fit locking engagement with the hook receiving means (13).

2. A percolator as claimed in claim 1, wherein said hook receiving means (13) comprise at least one seat (13) formed on the cup-shaped support (8) and extending transversely to said first and second axes (9, 29); and said hook means (52) comprise at least one hook (52) fitted to the lid (27) to oscillate, about a third axis (49) parallel to the second axis (29), to and from an engaged position engaging said seat (13).

3. A percolator as claimed in claim 1, and comprising a handgrip (45) for moving said lid (27) about the second axis (29); said hook means (52) forming part of said handgrip (45).

4. A percolator as claimed in claim 3, wherein said handgrip (45) comprises two rocker arms (46) fitted to the lid (27), on opposite sides of the lid (27), to oscillate, with respect to the lid (27), about a third axis (49) parallel to the second axis (29); each rocker arm (46) comprising a first and a second arm (50, 51); said first arms (50) being integral with each other; and said hook means (52) being carried by said second arms (51).

5. A percolator as claimed in claim 4, and comprising, for each said second arm (51), a seat (13) formed on the cup-shaped support (8); said hook means (52) comprising, for each said second arm (51), a hook (52) formed on an end portion of the second arm (51) and movable with the relative rocker arm (46) to and from an engaged position slidably engaging said seat (13).
